(19) United States
(12) Patent Application Publication
(10) Pub. No.: US 2002/0064362 A1
(43) Pub. Date: May 30, 2002

(54) Jig for optical fibers to manufacture fused couplers

(75) Inventors: Shih Chen Chou, Miaoli (TW); Shing-Lung Ting, Kaohsiung Hsien (TW); Bou-Yen Lai, Chiai Hsien (TW)

Correspondence Address: Richard P. Berg. Esq., c/o LADAS & PARRY, Suite 2100, 5670 Wilshire Boulevard, Los Angeles, CA, 90036-5679, US

(73) Assignee: U-CONN TECHNOLOGY INC.

(21) Appl. No.: 09/960,805

(22) Filed: Sep. 21, 2001

(30) Foreign Application Priority Data
Nov. 29, 2000 (TW) 89220720

(51) Int. Cl. G02B 6/00; G02B 6/26

(52) U.S. Cl. 385/134; 385/43

(57) ABSTRACT

A jig for optical fibers to manufacture fused couplers includes a guide rail, at least one slider, two vacuum bases and at least one ceramic power output element. The slider is mounted on the guide rail. The vacuum bases are used to fix the optical fibers, while one of the vacuum bases is fixed to the slider. The ceramic power output elements drive the slider to move on the guide rail.

### BACKGROUND OF THE INVENTION

1. Field of the Invention

The present invention relates in general to a jig for optical fibers to manufacture fused couplers that promotes yield and lower production costs.

2. Description of the Related Art

Referring to FIG. 7, a fused coupler includes two optical fibers fused together at a point 7. Light propagates in the left portion of either optical fiber, through the fused point 7 and separately into the right portions of the optical fibers. The energy of the light allotted to the right portions of the optical fibers can be equal or different, which depends on the specification of manufacture.

The two optical fibers are fused by heating the point 7, causing an elongation of the optical fibers. Then, the optical fibers sag during the fusing operation, causing a loss of light energy. The more the optical fibers sag, the more energy is lost. To prevent the problem, each optical fiber is necessarily kept under tension during the welding process. Conventionally, the optical fibers are fixed to jigs at their ends. During the fusing operation, the jigs are moved in opposite directions by step motors, couplers and screw rods to prevent the optical fibers from sagging.

However, the displacement of sagging of the optical fibers during the fusing operation is very small. The output displacements of the step motors fail to accurately eliminate the sagging of the optical fibers. Furthermore, conventional step motors and couplers tend to vibrate and chatter during operation, seriously influencing yield. Furthermore, the cost of building the jigs for the fused couplers is high.

### SUMMARY OF THE INVENTION

An object of the present invention is to provide a jig for optical fibers to manufacture fused couplers that promotes yield and lower costs.

The jig of the present invention includes a guide rail, at least one slider, two vacuum bases and at least one ceramic power output element. The slider is mounted on the guide rail. The vacuum bases are used to fix the optical fibers, with one of the vacuum bases fixed to the slider. The ceramic power output elements drive the slider to move on the guide rail.

The ceramic power output element outputs much more accurate displacement than step motors, to correctly eliminate the sagging of the optical fibers. Therefore, the yield of the fused couplers in the manufacturing process is greatly promoted using the present invention.

Furthermore, the ceramic power output elements always provide stable output without the problem of vibration and chatter of the conventional step motor and coupler. This also promotes the yield.

Furthermore, the total cost of the jig of the present invention is less than that in the prior art.

### BRIEF DESCRIPTION OF THE DRAWINGS

The present invention can be more fully understood by reading the subsequent detailed description and examples with references made to the accompanying drawings, wherein:

FIG. 1 is a perspective diagram of a jig for optical fibers to manufacture fused couplers in accordance with the present invention;

FIG. 2 depicts the path of the output shaft of the ceramic power output element of the present invention;

FIG. 3 is a front view of the vacuum base of the present invention;

FIG. 4 is a top view of the jig of the present invention;

FIG. 5 is an enlarged local view of FIG. 4;

FIG. 6 depicts the peripheral devices for the jig of the present invention; and

FIG. 7 is a schematic diagram of a fused coupler.

### DETAILED DESCRIPTION OF THE PREFERRED EMBODIMENT

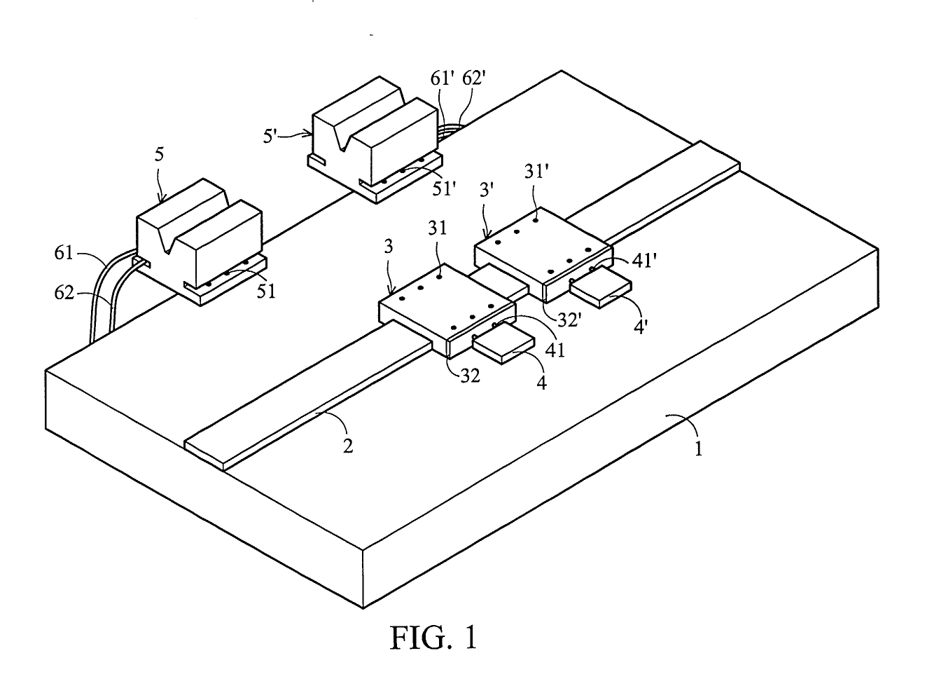

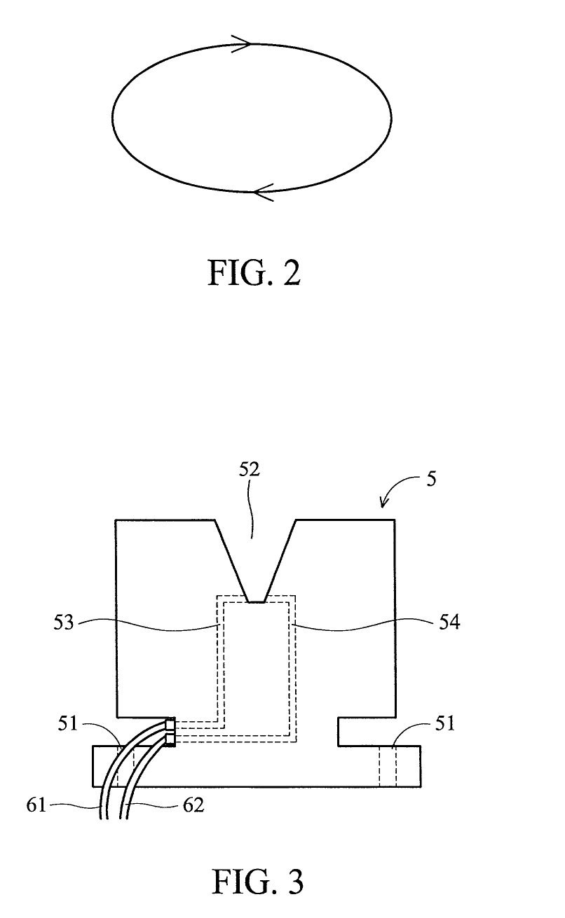

Referring to FIG. 1, a jig of the present invention includes a worktable 1, a guide rail 2 fixed on the worktable 1, and two sliders 3, 3′ mounted on the guide rail 2. Two ceramic plates 32, 32′ are fixed to side surfaces of the sliders 3, 3′. The main ingredient of the ceramic plates 32, 32′ is Al₂O₃. Two ceramic power output elements (e.g. ceramic linear motors) 4, 4′ are fixed on the worktable 1. The output shafts 41, 41′ of the ceramic power output elements 4, 4′ push against the ceramic plates 32, 32′ for driving the sliders 3, 3′ on the guide rail 2. Also referring to FIG. 2, the output shafts 41, 41′ of the ceramic power output elements 4, 4′ move in elliptical paths, different from those of conventional motors (the output shafts of conventional motors spin). The ceramic power output elements are commercially available and therefore are not introduced. The output shafts 41, 41′ of the ceramic power output elements 4, 4′ move in elliptical paths in opposite directions and drive the sliders 3, 3′ through the ceramic plates 32, 32′. Then, the sliders 3, 3′ slide on the guide rails 2 in opposite directions in a reciprocating manner.

The jig of the present invention further includes two vacuum bases 5, 5′. The vacuum bases 5, 5′ have screw holes 51, 51′ on their bottoms, through which the vacuum bases 5, 5′ are screwed to the sliders 3, 3′. Thus, the ceramic power output elements 4, 4′ are able to drive the vacuum bases 5, 5′ through the sliders 3, 3′. In this embodiment, the vacuum bases 5, 5′ have the same structure. For easy description, only the vacuum base 5 is introduced. Referring to FIG. 3, the vacuum base 5 has a V-shaped groove 52 on its top. In the V-shaped groove 52 are provided two rows of holes 53, 54. The holes 53, 54 are connected to an air compressor (not shown) via air pipes 61, 62. Then, vacuum attraction can be provided in the groove 52. It is noted that the holes 53, 54 are connected to different air pipes 61, 62 so as to individually provide vacuum attraction. For example, the hole 53 provides vacuum attraction while the hole 54 provides no vacuum attraction. Alternatively, both of the holes 53, 54 provide vacuum attraction. The user controls the operation.

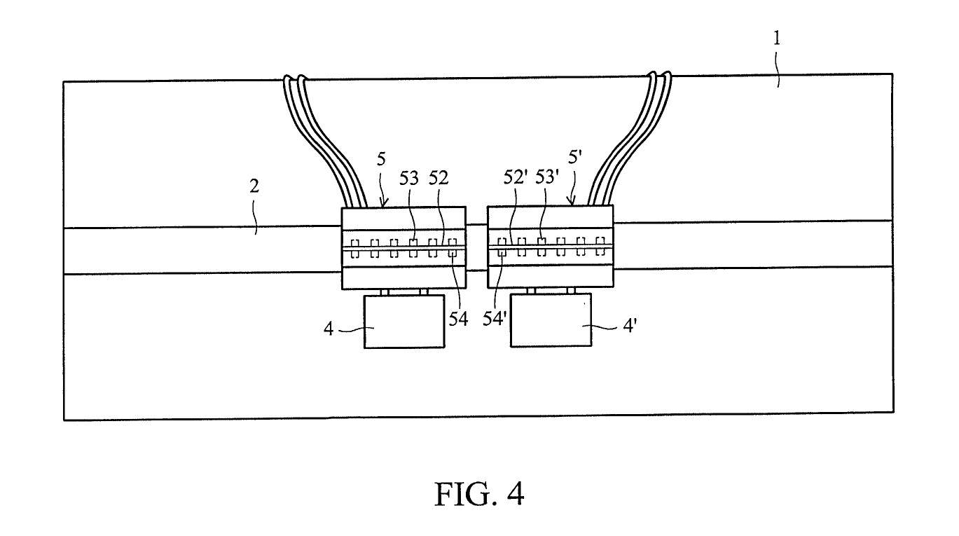

Referring to FIG. 4, in operation, two optical fibers are fixed by the jig of the present invention via vacuum attraction. The two optical fibers are crossed between the vacuum bases 5, 5′. Then, the intersection of the optical fibers is heated so that the optical fibers are fused together. The detail of the operation is as follows:

(Step 1) The air compressor is started. The holes 53, 53′ provide vacuum attraction while the holes 54, 54′ provide no attraction. Then, a first optical fiber is put in the V-shaped groove 52, 52′ and is immediately attracted by the holes 53, 53′.

(Step 2) The holes 54, 54′ start to provide vacuum attraction. A second optical fiber is put in the V-shaped groove in a manner that the second optical fiber is parallel to the first optical fiber. The second optical fiber is immediately attracted by the holes 54, 54′. Then, the first and second optical fibers are hand tightened.

(Step 3) The vacuum attraction provided by the hole 54 is terminated to release the right half of the second optical fiber. Then, the worker holds the right half of the second optical fiber to intersect the first optical fiber, with the intersection of the first and second optical fibers maintained at a position between the vacuum bases 5, 5′.

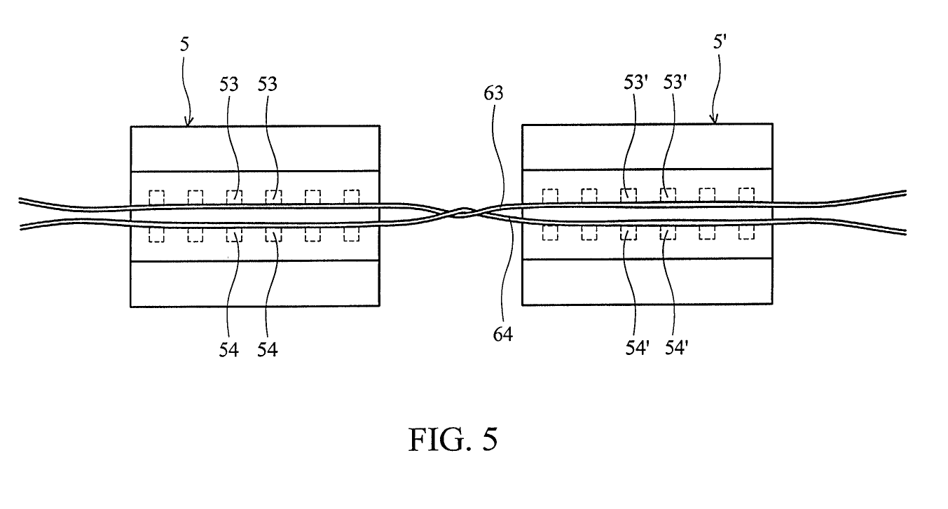

(Step 4) The hole 54′ starts to provide vacuum attraction. The worker re-tightens the first and second optical fibers so that the intersection of the first and second optical fibers is positioned at the middle between the vacuum bases. The result is shown in FIG. 5, in which reference numerals 63, 64 represent the first and second optical fibers, respectively.

Then, the intersection of the first and second optical fibers is heated and fused:

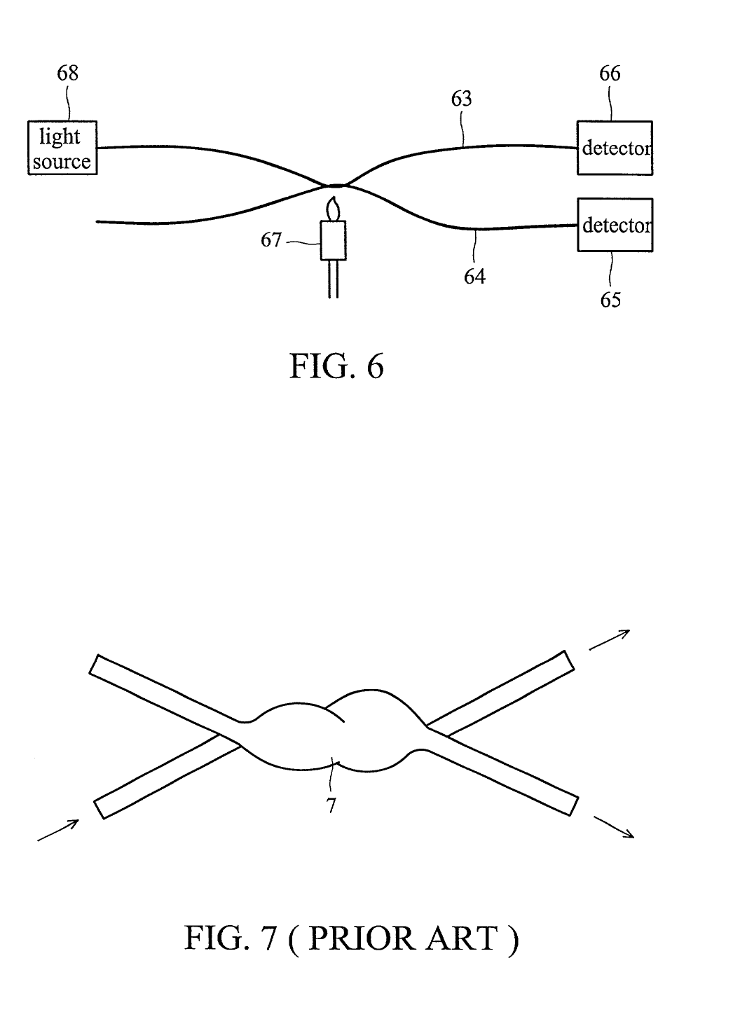

Referring to FIG. 6, the first optical fiber 63 connects a light source 68 and a detector 66, while the second optical fiber 64 is connected to a detector 65. A light signal is emitted by the light source 68, transmitted in the first optical fiber 63 and received by the detectors 65, 66. Before the fusing operation, the detector 66 receives 100% of the light energy and the detector 65 receives none. During the fusing operation, the worker heats the intersection with a flame source 67. Then, a part of the light signal is transmitted into the second optical fiber 64 and received by the detector 65. The fused zone expands so that more light energy is transmitted to the second optical fiber 64 and received by the detector 65. The fusing time depends on the manufacturer's specification. For example, the specification is 50%-50% for the output ends of the fused coupler. Then, the flame source 67 is removed as soon as each of the detectors 65, 66 receives 50% of light energy.

The optical fibers 63, 64 are elongated by heating and automatically sag, which causes unexpected energy loss of the output signal. To prevent this, the optical fibers 63, 64 have to be kept under tension during the fusing operation. In the present invention, the ceramic power output elements 4, 4′ move the vacuum bases 5, 5′ in opposite directions to keep the optical fibers 63, 64 under tension, thereby solving the problem of energy loss during the fusing operation.

The above embodiment can be modified as follows: During the fusing operation, one ceramic power output element 4′ operates while the other ceramic power output element 4 does not operate. Then, one vacuum base 5′ is moved while the other vacuum base 5 is stationary. It is understood that this arrangement also keeps the optical fibers 63, 64 under tension during the fusing operation.

The ceramic power output elements in the present invention are used for their displacement accuracy. During the fusing operation, the optical fibers sag in a very small displacement that cannot be correctly eliminated by step motors (prior art). The ceramic power output elements output much more accurate displacements than the step motors, to correctly eliminate the sagging of the optical fibers. Therefore, the yield of the fused couplers in the manufacturing process is greatly promoted by using the present invention.

Another reason is that the ceramic power output elements always provide stable output without the problems of vibration and chatter as with the conventional step motor and coupler. This also promotes yield.

Another reason is the total cost of the jig of the present invention is less than that in the prior art.

While the invention has been described by way of example and in terms of the preferred embodiment, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A jig for optical fibers, comprising:
a guide rail;
two sliders mounted on the guide rail;
two vacuum bases fixed to the sliders to fix the optical fibers;
two ceramic power output elements driving the sliders to move on the guide rail.

2. A jig as claimed in claim 1, wherein each of the vacuum bases has a groove to accommodate the optical fibers.

3. A jig as claimed in claim 2, further comprising an air compressor, each of the vacuum bases further having at least one hole in the groove, the hole connected to the air compressor, and the air compressor generating vacuum attraction to attract the optical fibers via the hole.

4. A jig as claimed in claim 1, further comprising two plates fixed to the sliders, the ceramic power output elements having output shafts against the plates, and the ceramic power output elements driving the sliders via the plates.

5. A jig as claimed in claim 4, wherein the plates are ceramic.

6. A jig as claimed in claim 5, wherein the ceramic includes Al₂O₃.

7. A jig as claimed in claim 4, wherein the output shafts of the ceramic power output elements move in elliptical paths.

8. A jig for optical fibers, comprising:
a guide rail;
a slider mounted on the guide rail;
a stationary element;
two vacuum bases fixed to the slider and the stationary element to fix the optical fibers; and
a ceramic power output element driving the slider to move on the guide rail.

9. A jig as claimed in claim 8, wherein each of the vacuum bases has a groove to accommodate the optical fibers.

10. A jig as claimed in claim 9, further comprising an air compressor, each of the vacuum bases further having at least one hole in the groove, the hole connected to the air compressor, and the air compressor generating vacuum attraction to attract the optical fibers via the hole.

11. A jig as claimed in claim 8, further comprising a plate fixed to the slider, the ceramic power output element having an output shaft against the plate, and the ceramic power output element driving the slider via the plate.

12. A jig as claimed in claim 11, wherein the plate is ceramic.

13. A jig as claimed in claim 12, wherein the ceramic includes Al₂O₃.

14. A jig as claimed in claim 11, wherein the output shaft of the ceramic power output element moves in an elliptical path.
